(19) United States
(12) Patent Application Publication
(10) Pub. No.: US 2006/0182607 A1
(43) Pub. Date: Aug. 17, 2006

(54) Method and apparatus for depalletizing bagged products

(76) Inventors: Jason Alexander Clark, Portland, OR (US); Richard James Sampson, Vancouver, WA (US)

Correspondence Address: MARGER JOHNSON & MCCOLLOM, P.C., 210 SW MORRISON STREET, SUITE 400, PORTLAND, OR, 97204, US

(21) Appl. No.: 11/038,748

(22) Filed: Jan. 18, 2005

(51) Int. Cl. B66C 23/00

(52) U.S. Cl. 414/744.5

(57) ABSTRACT

The parts of the machine, in broad concept, have been confirmed as follows: (1) a robotic arm; (2) a vacuum end effector [two cups] affixed to the terminal end of the robotic arm; (3) a vacuum source coupled to the vacuum end effector; (4) programmable means for moving the robotic arm terminal end between a pick-up point and a drop point; (5) said programmable means operating the robotic arm such that products picked up by the vacuum end effector are at least partially dragged from the pick-up point to the drop point.

### BACKGROUND OF THE INVENTION

1. Field of the Invention

This invention relates generally to suction lifting devices and particularly those used to move deformable products such as bags filled with seeds.

2. Description of the Prior Art

Vacuum lifting devices use vacuum suction to engage with the object to be moved. The lifting strength of the device depends upon the vacuum pressure applied, the area over which the pressure is applied, and the quality of the seal between the lifting device (often a suction cup with a rubber or close-cell foam peripheral seal) and the object to be moved.

Problems occur when the object to be moved is a deformable object such that the bare act of lifting the object causes the surface of the object, and particularly the surface engaged with the lifting device, to deform and break the seal with the lifting device. Bagged products, such as seeds and the like, suffer from this problem. As the seed bag is moved, gravity acting upon the seeds shift the seeds within the bag and deform the bag surface.

Methods used to counteract this problem include increasing the vacuum pressure and increasing the size of the vacuum cup used to engage with the bag. Too much vacuum pressure has the possibility of rupturing the bag surface. The drawback to using larger vacuum cups is that the cups must then be accurately placed on the bag since there is very little tolerance. Inaccurately placing the vacuum cup, say along an edge of the bag, would form an imperfect seal. Additionally, such systems require that the bags be picked up very gingerly since rapid centripetal movement will oftentimes disengage the bag from the suction mechanism. The larger the vacuum cup relative to the size of the bag, the greater the problem. Accordingly, state-of-the-art lifting mechanisms use expensive and complicated machine vision systems to accurately place the large vacuum cup on the bag. Given the complexity of such systems, however, an alternative is desired.

### SUMMARY OF THE INVENTION

An apparatus for moving bagged products comprises a robotic arm, a vacuum end effector affixed to the terminal end of the robotic arm, and a vacuum source coupled to the vacuum end effector. The apparatus includes programmable means for moving the robotic arm terminal end between a pick-up point and a drop point, whereby the programmable means operate the robotic arm such that products picked up by the vacuum end effector are at least partially dragged from the pick-up point to the drop point.

The invention further comprises a method for moving bagged products from a pick-up point on a supporting surface to a drop point. The bagged product is typically enclosed with an envelope such as a bag of plastic sheeting. The method for moving the bag includes applying a vacuum pressure through an end effector to a bag resting on a supporting surface and lifting the bag product so that at least a portion of the bag remains in contact with the supporting surface. The end effector is then moved, as using a robotic arm under programmable control, in a direction of intended movement so that the bag is partially dragged along said direction of intended movement. The end effector is then disengaged from the bag at the drop point.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIGS. 1-11 are perspective views of the depalletizing apparatus configured according to a preferred embodiment of the invention.

FIG. 12 is a plan view of the depalletizing apparatus of FIG. 1.

FIG. 13 is a side elevation view of the apparatus of FIG. 1.

FIGS. 14-15 are side sectional views of a vacuum end effector in off-center engagement with a seed bag for partial dragging movement off of the pallet according to a preferred method of operation.

FIGS. 16-17 are side elevation views of the pallet lifting mechanism configured according to a preferred embodiment of the invention.

FIG. 18 is a side section view of a vacuum end effector in engagement with a single seed bag.

FIG. 19 is a flow diagram illustrating the operation of the depalletizing process according to a preferred implementation of the invention.

### DETAILED DESCRIPTION

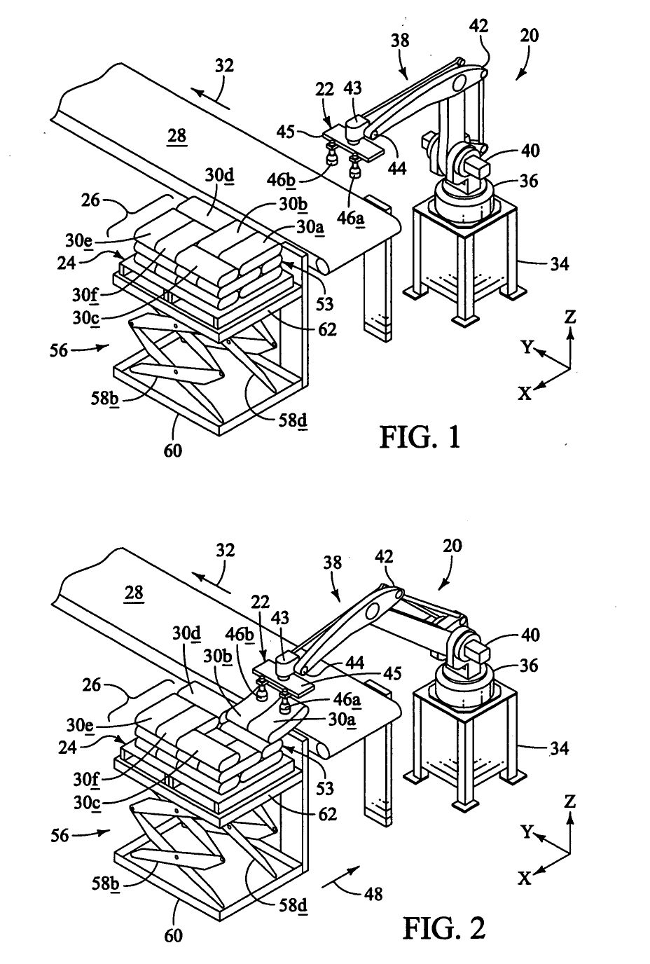

FIGS. 1-11 illustrate in perspective view the operation of the invention through a complete cycle to move a layer of bagged products, stacked on a pallet, onto a conveyor belt. Shown in FIG. 1 in the home position, the parts of the apparatus used in the conveyance operation include a robotic arm assembly 20, a vacuum end effector 22 affixed to the terminal end of the robotic arm; a vacuum source coupled to the vacuum end effector, and programmable means for moving the robotic arm terminal end between a pick-up point and a drop point. Here the pick-up point is from a pallet 24 of stacked bagged products 26, and the drop off point is a conveyor belt 28 operable to move the bagged products, such as seed bags 30a, 30b, and 30c, downstream from the pallet 24 in the direction of arrow 32.

The mechanical components of robotic arm assembly 20 are of conventional design and only described in bare detail here. Such components are available from Columbia Okura, Inc. of Vancouver, Wash. Assembly 20 includes a base 34 for supporting the assembly under load. A rotating platform 36 sits atop base 34 and rotates about a vertical axis under control of drive means well known in the art. A robotic arm 38 is attached to rotating platform 36 via hinge 40 and includes both an elbow hinge 42 midway along the length of robotic arm 38 and a wrist hinge 44 at the distal end of the robotic arm adjacent vacuum end effector 22.

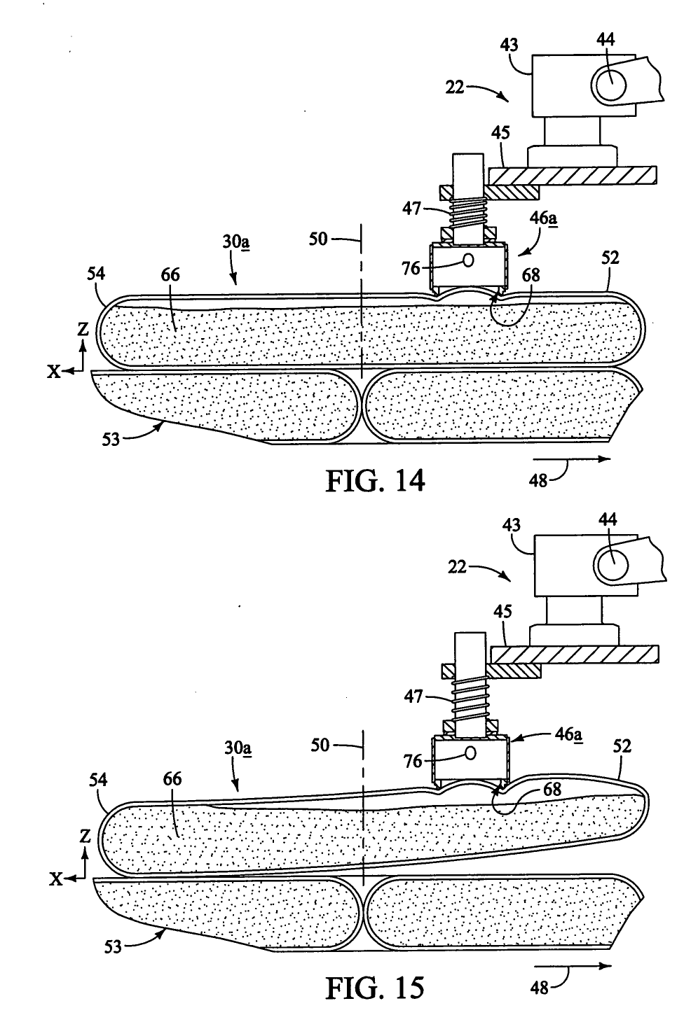

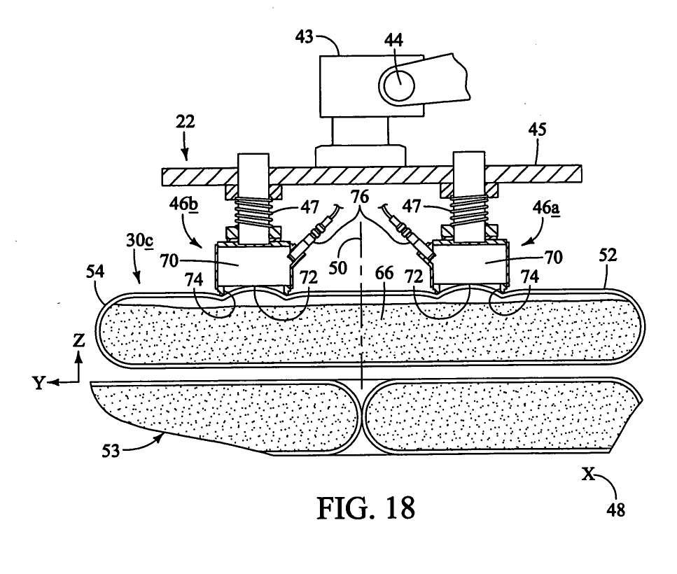

The vacuum end effector 22 rotates under computer or manual control about a vertical z-axis between 0 and ±90° via a rotating gear within effector rotator 43 and comprises two suction cups 46a, 46b coupled to a 17 horsepower vacuum blower. A horizontal bar 45 (FIG. 18) is attached at the end of the effector. Each of the cups 46a, 46b is spaced along the length of the horizontal bar and may be moved closer together or further apart from one another as the situation requires. As will be appreciated from the description further below, larger bags may require the cups to be fixed along the bar further apart so that each bag may be engaged by a respective vacuum cup. As shown in FIGS. 14 and 15, the cups are biased by a spring 47 to travel along a vertical “stroke” (4-8″ preferred) so that they each may engage with the same bag or different bags at independent heights. The vacuum source is operated by a high power blower (17 hp) communicated equally to the two cups 46a, 46b.

Robotic arm assembly 20 is operated under control of programmable means (not shown) to move the arm and attached vacuum end effector 22 in proper position to pick up and drop off bagged products 26 whereby at least some of the bagged products, namely seed bags 30a and 30b in FIG. 2, are partially dragged from the pick-up point to the drop point. The programmable means, via computer control, works off of x-y-z coordinates so that the arm runs through a series of sequential movement for each layer in the palletized stack 26. In the embodiment shown, the stack of bagged products 26 are arranged in a 2×1/1×2 arrangement for each layer.

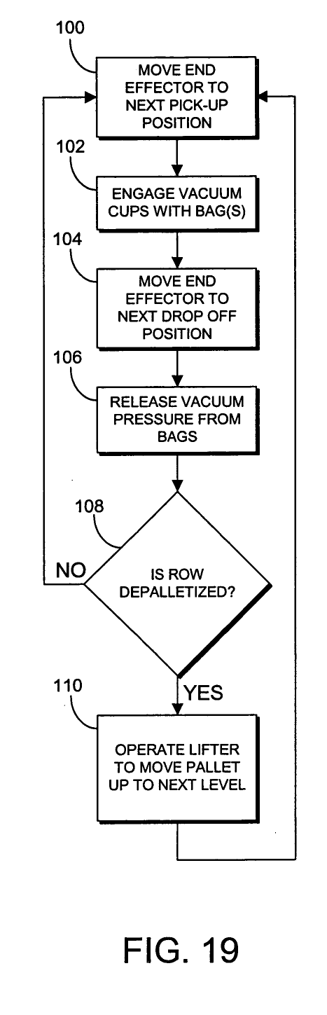

FIG. 19 illustrates the sequential operation of the robotic arm assembly 20, with additional reference to FIGS. 1-11, to move a row of bagged products 30a-30f onto a downstream conveyor 28. Programming control looks up the x-y-z coordinates for the next pick-up position in block 100 and moves end effector 22 into proper position for engagement with the bag or bags 30 at that position. Movement of the arm assembly 20 is effected by operating the moveable elements on the assembly 20 in order to locate end effector 22 and particularly vacuum cups 26a, 26b in the proper position. These moveable elements include rotating platform 36, hinges 40, 42, and 44, and effector rotator 43.

Turning to FIG. 2, programming means controls the movement of the robotic arm assembly 10 to move effector 22 over two of the bags 30a, 30b and lowers the cups 46a, 46b so that each cup engages a respective bag. Positioning end effector 22 properly entails, if using a system without machine vision, a knowledge of the approximate location of the bags to be moved. First step movement of end effector involves closing the angle of hinge 40 while extending the angle of hinges 42 and 44 so that the end effector is moved from a home position (shown in FIG. 1) to a position allowing engagement of the bags as in FIG. 2. Such engagement position is shown in side view in FIG. 14. In block 102 (FIG. 19), the vacuum source is communicated to vacuum cups 46a, 46b and the cups engaged with bags 30a, 30b. As shown in FIG. 14, the cups engage off-center (to the right of center line 50) from the bag so that the leading edge 52 of the bag 30a—that is that edge of the bag 30a closest to the direction of intended movement 48—is picked up off the layer beneath 53. The programmable means operating movement of the robotic arm assembly 20 causes the vacuum end effector to move upward only a predetermined amount so that the trailing edge 54 of the bags 30a, 30b drags across the layer 53 to the adjacent out-feed conveyor 28. The position of the bags during this dragged movement process is shown best in FIG. 15. The end effector is then moved to the next drop-off position in block 104 (FIG. 19).

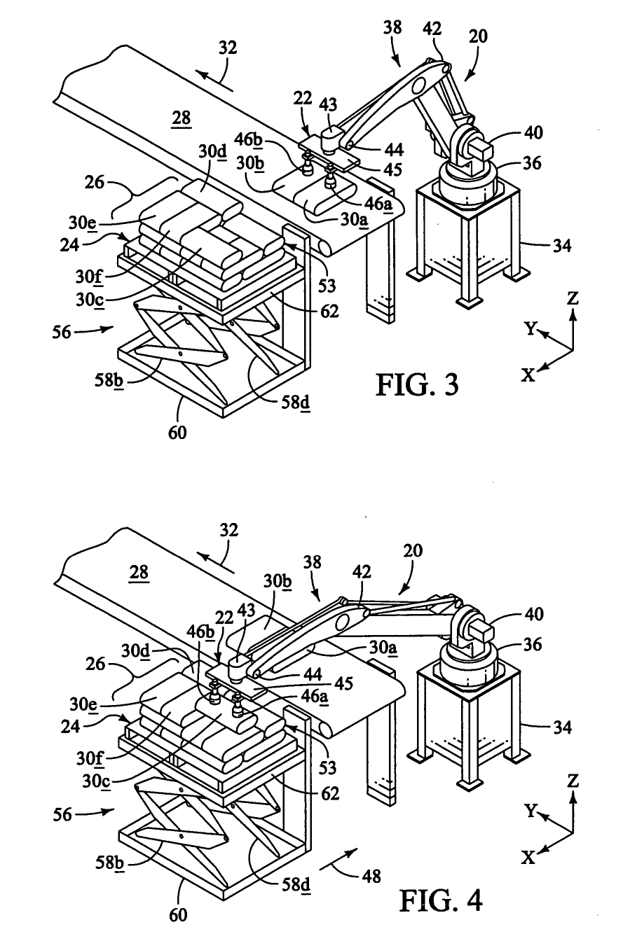

As shown in FIGS. 3 and 4, end effector 22 releases the bags 30a, 30b (block 106) onto conveyor 28 where the bags are carried downstream 32. Query block 108 then operates in programming means to determine whether the layer has been depalletized. If not, as in the present example, then operation moves to block 100. Effector 22 moves to the second preprogrammed position over the single bag 30c. As second position is further away from robotic arm base 34 than the first position shown in FIG. 2, programming means operating the robotic arm assembly 20 close hinge 40 and extend hinges 42 and 44 to allow robotic arm 38 to reach out further over pallet stack 26. Both cups 46a, 46b lower into engagement with single bag 30c and lift it completely from the pallet stack 26. This lift is shown best in FIG. 18.

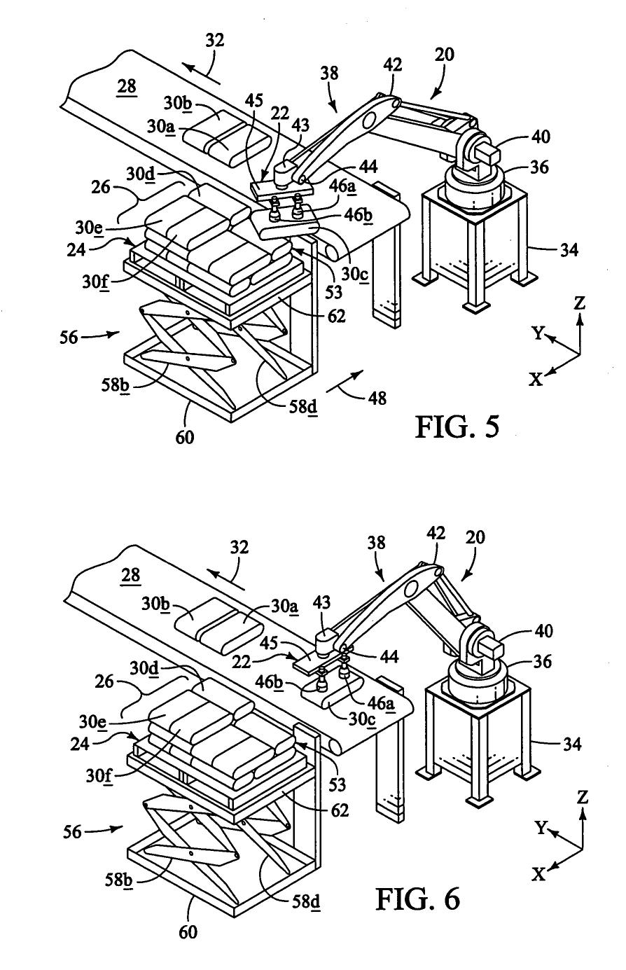

Turning to FIGS. 5 and 6, the effector 22 is rotated 90° until the bag 30c long axis is lined up with the long axes of previously placed bags 30a, 30b. FIG. 18 shows a side sectional view of such an arrangement. Bag 30c is moved and then placed on conveyor 28 where the bag is carried downstream 32 behind the previously placed bags 30a, 30b.

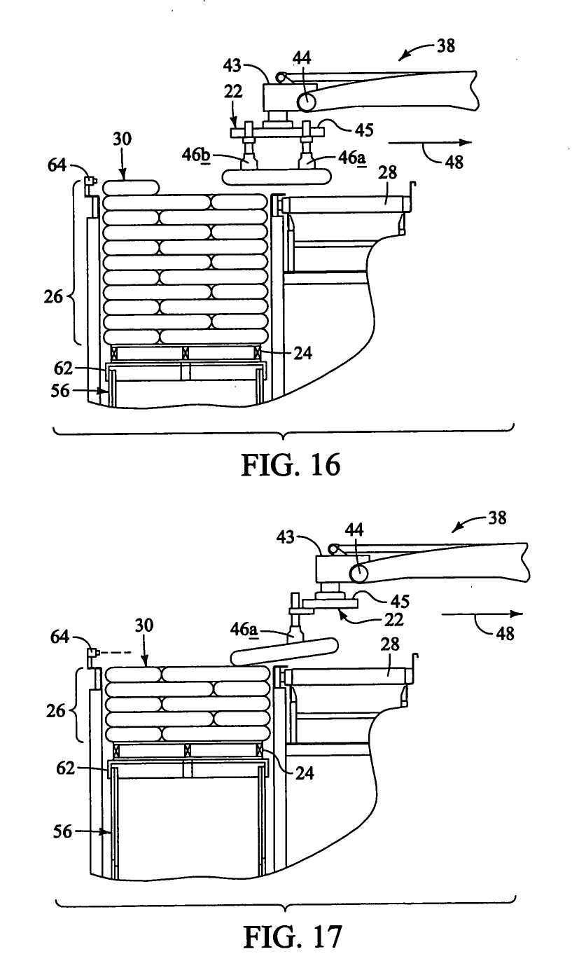

Attention is now given to the configuration of the vacuum cups used to engage with the products moved, such as cups 46a, 46b in engagement with seed bag 30c in FIG. 18. Each vacuum cup, such as cup 46a, includes in a preferred embodiment a chamber 70 defining a downward-facing opening 72. Vacuum pressure is communicated to chamber 70 from a vacuum source. The vacuum pressure is further communicated through opening 72 to the bag 30c below. Opening 72 in a preferred embodiment defines a square-shaped opening of an approximate dimension of 4½″ to 5¼″. Peripheral edges of opening 72 include a stepped or sharp edge 74. When vacuum source is turned on and cup 46a is engaged with bag 30, such as shown in FIG. 18, the outer envelope of seed bag 30c is pulled through vacuum cup opening 72 and against edges 74. It has been found that the sharper edge 74 inside the square cup provides a surface for the bag material to contact which increases the force required to decouple the bag from the cup while dragging it to the downstream conveyor. No foam seal is required to effect a good vacuum seal on the bag. Should the bag become decoupled, however, vacuum cup 46a includes sensors, such as photodetector 776, that pier into the interior of chamber 70 toward opening 72 to determine whether bag 30c continues to be engaged. Engaged bags cause the chamber to become dark; disengaged bags allows light to pass through to the detector thus triggering a warning that the bag has been disengaged prematurely. The control program operating the depalletizing sequence is then interrupted and end effector 22 dropped to reengage the bag 30c. Dragging the bag as in FIG. 15 (and FIG. 17) has shown to work best when the vacuum cup 46a is positioned near the front end 52 of bag and the bag lifted only a minimal height off of the supporting surface (here layer 53) below. In FIG. 18, in contrast, a bag engaged with both vacuum cups 46a, 46b, is engaged on either side of center line 50 and completely picked up from supporting layer 53 and then moved in a direction into the page shown by ‘X’ 48. Such is also shown in FIG. 16.

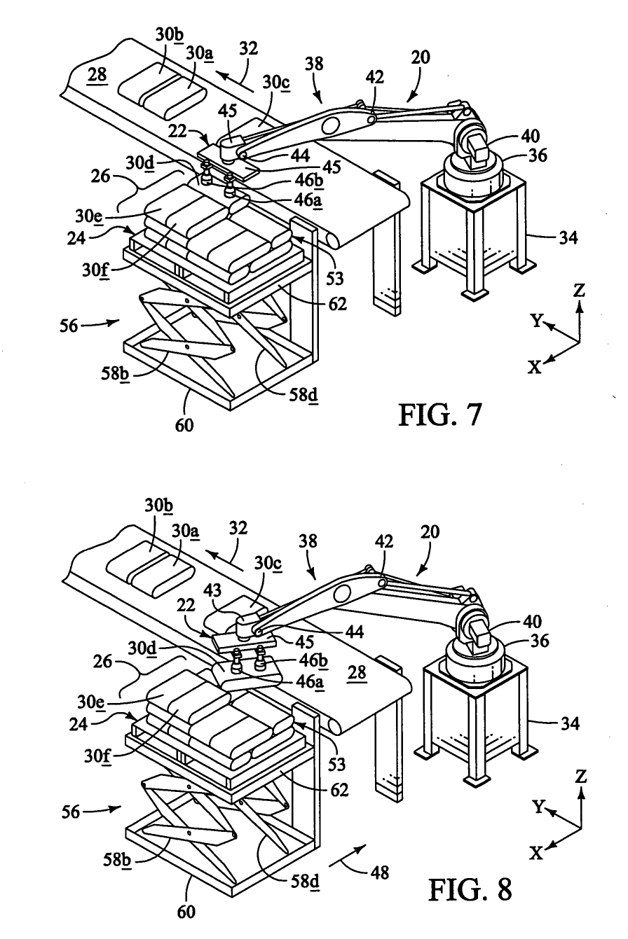

Turning next to FIGS. 7 and 8, effector rotator 43 rotates effector 22 by 90° back to its initial position. Both cups 46a, 46b are then lowered into engagement with the single bag 30d at a third preprogrammed position. Programming means controls the robotic arm assembly 20 movement so that rotating platform 36 is rotated a few degrees, and end effector rotator 43 counter-rotates end effector 22 a few degrees, to allow arm 38 to reach out and engage single bag 30d. The bag 30d is completely picked up, rotated, and placed on the conveyor in the same fashion as bag 30c.

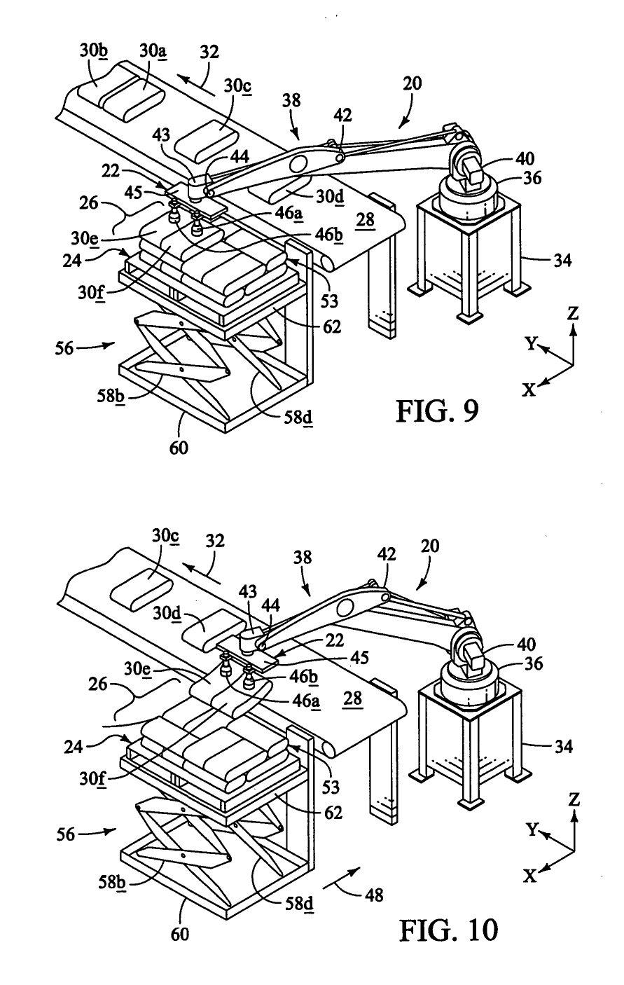

In FIGS. 9 and 10, robotic arm 38 then moves to the fourth pre-programmed position over the other set of double bags 30e, 30f. The effector 22 is rotated back to 0 degrees. Both bags 30e, 30f are engaged by a single respective suction cup 46a, 46b and then partially dragged over the layer 53 below to the outfeed conveyor 28.

The programming means operating the robotic arm assembly 22 moves from query block 108 to block 110 since the step illustrated in FIGS. 9 and 10 represent the last step in depalletizing the layer. Lifter 56 is then operated in block 110 (FIG. 19) to raise pallet 24 sitting atop it to the next level so that layer 53 can be depalletized in the same manner as the layer above. As each layer is removed from the pallet by the robotic arm 38, the pallet 24 is lifted from below to present the next layer to a receiving position.

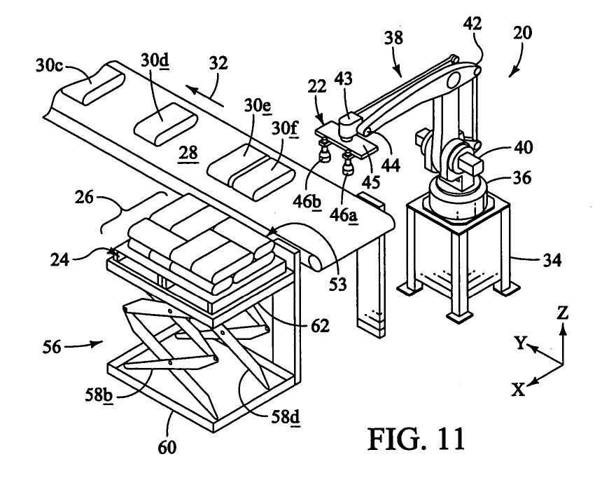

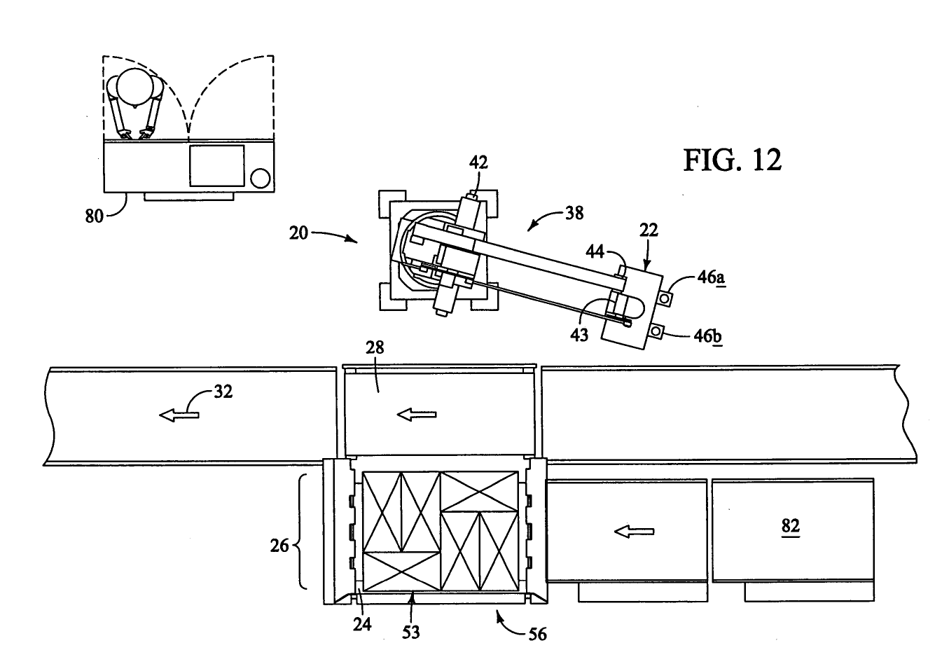

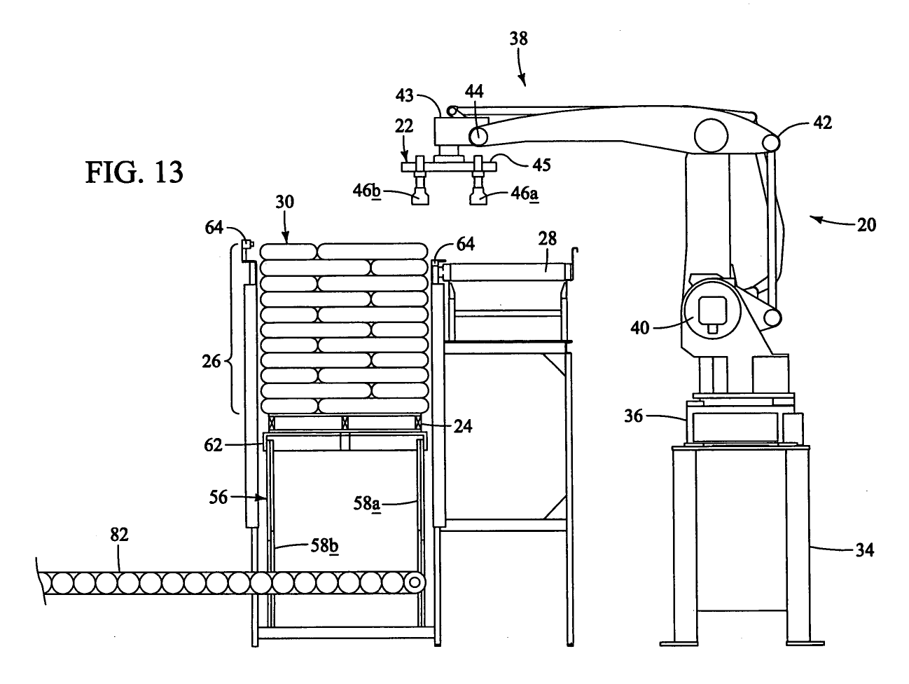

Turning to FIG. 11, lifter 56 raises by way of scissoring arms 58a, 58b coupled between base 60 and platform 62, until the next layer 53 on the pallet triggers an electronic eye 64 at which point the proper height of the next layer is obtained and the lift mechanism 56 temporarily deactivated. Such an arrangement is shown best in the side elevation view of FIG. 13. Lifter assembly 56 may also be raised and then stopped using an indexed raising means whereby gears lifting the arms are rotated a set amount and then stopped. The effector then picks and places (for single bags) or drags and drops (for double bags) in reverse order from the previous layer since the bag arrangements are staggered between layers.

Although the lifter is an important part of the invention, an important aspect of the preferred embodiment of the invention is arranging the bags so that the bags 30 to be moved are sitting on a surface that is at approximately the same level as the out-feed conveyor. Accordingly, the pallet 24 can be moved up as the pallet is unloaded layer by layer (as with the lifter), or the out-feed conveyor 28 can be lowered as each layer from the pallet is unloaded. Placing the bags to be unloaded and the outfeed conveyor on approximately the same level reduces the stress of dragging the bags since dropping the bags from too high a height, or moving the bags over rough terrain could potentially make the bags burst open and spill their contents all over the shop floor.

FIG. 11 shows a plan view of the bag depalletizing apparatus including robotic arm assembly 20, a control station 80 including programming means for operating the apparatus, lifter assembly 56 with pallet 24 and stack 26 atop it, and outfeed conveyor 28. Pallets of bagged products may be moved into position on the lifter assembly 56 using a pallet transport conveyor 82 where empty pallets are carried away and full pallets moved into position for depalletizing.

FIG. 14 shows in section bag 30a sitting atop layer 53. Bag 30a includes a fairly even distribution of seed material 66 since bag 30a is sitting on a fairly level surface. End effector 22, and in particular vacuum cup 46a, is brought into engagement with an outer envelope of the bag. Vacuum pressure is applied and the envelope is pulled into the suction cup opening 68, and particularly against inwardly angled surfaces about the periphery of opening 68.

FIG. 15 shows the operation of the end effector 22 to partially lift bag 30a so that the leading edge 52 of bag 30a is lifted from the layer below 53 while the trailing edge 54 of the bag remains in contact with layer 53. The bag is then dragged in the direction of arrow 48 to the downstream conveyor 28. Note that the seed material 66 has shifted to the rear of the bag as the leading edge is lifted thus deforming the bag envelope. The vacuum cup 46a remains coupled to the bag envelope, however. This is in contrast with FIG. 18, in which both vacuum cups 46a, 46b engage bag 30c on either side of center line 50 so that the bag is evenly and completely picked up from the layer below 53. Bag 30c is then moved into the page along line 48 to outfeed conveyor 28.

One advantage of the machine over competing machines—e.g. those that pick up the entire bagged product and place it on an outfeed conveyor—is that the present design is better tailored to not require a machine vision system where the location of the end effector is identified by matching its location against the pattern of the bag located adjacent to the effector. Such systems are complicated to implement and increase costs. The idea behind prior art systems is that the vacuum suction cup needs to be larger (e.g. applies more suction force) to successfully engage with the bag and lift it completely off the ground. Larger cups means that the cups must be very accurately placed on the bag since there is very little tolerance. Additionally, such systems require that the bags be picked up very gingerly since rapid centripetal movement will oftentimes disengage the bag from the suction mechanism.

The present machine uses a smaller suction cup (thus smaller force) and thus can use preprogrammed robotic positioning to engage the cup with the bag. As the bags 30 shift during movement on the pallet 24, exact placement of the cups on the bag without complicated machine vision equipment is difficult. With smaller cups, however, the target area has a tolerance that is much easier to hit. Additionally, with smaller force the cup 46 is only (and need only) drag the bag across the pallet to the outfeed conveyor 28.

Having described and illustrated the principles of the invention in a preferred embodiment thereof, it should be apparent that the invention can be modified in arrangement and detail without departing from such principles. We claim all modifications and variation coming within the spirit and scope of the following claims.

What is claimed is:

1. An apparatus for moving bagged products comprising:
a robotic arm;
a vacuum end effector affixed to the terminal end of the robotic arm;
a vacuum source coupled to the vacuum end effector; and
programmable means for moving the robotic arm terminal end between a pick-up point and a drop point,
said programmable means operating the robotic arm such that products picked up by the vacuum end effector are at least partially dragged from the pick-up point to the drop point.

2. The apparatus of claim 1, wherein the vacuum end effector includes two vacuum cups spaced apart sufficient to engage two separate bagged products.

3. The apparatus of claim 2, wherein each of the two vacuum cups is independently moveable along a stroke and biased in an extended position.

4. The apparatus of claim 2, the vacuum end effector further including means for rotating the two vacuum cups about a rotational axis perpendicular to a supporting surface of the bagged products.

5. The apparatus of claim 1, wherein the vacuum end effector includes a vacuum cup having a square opening.

6. The apparatus of claim 5, wherein the opening the vacuum cup includes an edge perpendicular to a direction of intended movement from the pick-up point to the drop point.

7. The apparatus of claim 1, wherein the vacuum end effector includes a vacuum cup having a stepped interior surface.

8. The apparatus of claim 1, said programmable means adapted to rotate said vacuum end effector to a first position to engage with bagged products oriented in a first direction, and to rotate said vacuum end effector to a second position only after engagement with bagged products oriented in a second direction perpendicular with the first direction.

9. The apparatus of claim 8, said first direction being where a long axis of the bagged product is parallel to a direction of intended movement between the pick-up point and the drop point, said end effector including two vacuum cups whereby rotation of the vacuum end effector to the first position engages each of the vacuum cups with a separate bagged product.

10. The apparatus of claim 9, said second direction being where the long axis of the bagged product is perpendicular to the direction of intended movement, said two vacuum cups of the end effector both engaging a single bagged product.

11. A method for moving a bagged product, enclosed by a bag resting at a pick-up point on a supporting surface, to a drop point comprising:
applying a vacuum pressure through an end effector to a bag resting on a supporting surface;
lifting the bag product so that at least a portion of the bag remains in contact with the supporting surface;
moving the end effector in a direction of intended movement so that the bag is partially dragged along said direction of intended movement; and
disengaging the end effector from the bag at the drop point.

12. The method of claim 11, further including:
moving the end effector in contact with a second bag resting on the supporting surface at least two points on the bag surface;
lifting the bag completely from the supporting surface and moving the bag to the drop point; and
disengaging the end effector from the second bag.

13. The method of claim 12, further including the step of rotating the second bag 90 degrees prior to disengaging the end effector from the second bag.

14. The method of claim 11, wherein the step of applying a vacuum pressure to a bag includes applying said vacuum pressure at a point on the bag off center in the direction of intended movement so that a trailing portion of the bag remains in contact with the supporting surface during the lifting step.

15. The method of claim 11, further including the step of lifting bagged product stacked on a pallet to present a top row at the pick-up point.

16. The method of claim 15, further including the step of lifting a newly exposed row of the bagged product on the pallet up to the pick-up point once the top row has been moved by the end effector.

17. The method of claim 11, wherein said drop point is located on a conveyor system for transporting the disengaged bag from the drop point.
